(19) United States
(12) Patent Application Publication
(10) Pub. No.: US 2006/0290222 A1
(43) Pub. Date: Dec. 28, 2006

(54) Motor rotor

(75) Inventors: Te-Yang Shen, Taoyuan Hsien (TW); Nicco Yu, Taoyuan Hsien (TW); Ming Yeh, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/385,788

(22) Filed: Mar. 22, 2006

(30) Foreign Application Priority Data
Jun. 28, 2005 (TW) 094121532

(51) Int. Cl. H02K 21/12

(52) U.S. Cl. 310/156.56

(57) ABSTRACT

A motor rotor includes a rotor body, a shaft and a plurality of magnetic elements. The rotor body has a plurality of accommodating portions radially arranged around an axis of the rotor body. The shaft is disposed in the axis of the rotor body. The magnetic elements are respectively disposed in the accommodating portions. The magnetic element has an N pole and an S pole, and an interface is formed at a junction between the N pole and the S pole. An extending direction of the interface passes through the axis of the rotor body.

### BACKGROUND OF THE INVENTION

1. Field of Invention

The present invention relates to a motor rotor, and more particularly to a motor rotor with embedded magnets.

2. Related Art

In general, a motor mainly includes a rotor having permanent magnets and a stator having coils. The coils of the stator enable the rotor to rotate after the coils are charged. The commonly used rotors are classified into two types. One type is surface-magnet type by disposing the permanent magnets on the surface of the rotor. The other type is magnet-embedded type by disposing the permanent magnets in the slots of the rotor.

FIG. 1 is a perspective view showing a conventional motor rotor. A surface-magnet type rotor 1 mainly includes a rotor body 11, a shaft 12 and a plurality of permanent magnets 13. The rotor body 11 is composed of a plurality of silicon steel sheets. The permanent magnets 13 are adhered to the surface of the rotor body 11 such that the surface magnets of the rotor body 11 have N and S poles arranged alternately.

FIG. 2 is a perspective view showing another conventional motor rotor. A magnet-embedded type rotor 2 mainly includes a rotor body 21, a shaft 22 and a plurality of permanent magnets 23. The rotor body 21 is composed of a plurality of silicon steel sheets. A plurality of magnet slots 211 for accommodating the permanent magnets 23 is formed on the outer circumference of the rotor body 21. Thus, the magnets in the rotor body 21 have N and S poles arranged alternately.

Without changing the diameters and the lengths of the rotor bodies 11 and 21 and the disposition of the permanent magnets 13 and 23, the number of poles of the motor must be increased or the spaces must be reduced for raising the power density and the torsion of the motor. For example, the rotor 2 in FIG. 2 has 6 poles. As shown in FIG. 3, if the number of poles of the rotor 2 is increased to 8, the surface area occupied by each permanent magnet 23 is relatively reduced under the limitation of the surface area of the rotor body 21. The magnetic flux density of the rotor 2 is thus adversely reduced. In addition, reducing the space must raise the precision of the surface treatment of the rotor, thereby resulting in an increase of the manufacturing cost.

It is thus imperative to provide a rotor without changing the length and the area of the rotor body for increasing the number of poles and simultaneously raising the torsion of the motor.

### SUMMARY OF THE INVENTION

In view of the foregoing, the present invention provides a motor rotor having a plurality of accommodating portions for respectively accommodating a plurality of magnetic elements, and the accommodating portions are radially arranged around an axis.

To achieve the above, a motor rotor according to the present invention includes a rotor body, a shaft and a plurality of magnetic elements. The rotor body has a plurality of accommodating portions radially arranged around an axis of the rotor body. The shaft is disposed in the axis of the rotor body. The magnetic elements are respectively disposed in the accommodating portions. The magnetic element has an N pole and an S pole. An interface is formed at a junction between the N pole and the S pole. The extending direction of the interface passes through the axis of the rotor body.

To achieve the above, another motor rotor according to the present invention includes a rotor body, a shaft and a plurality of magnetic elements. The rotor body has a through hole disposed in an axis of the rotor body, and a plurality of accommodating portions radially arranged around the axis of the rotor body. The shaft is disposed in the through hole. The magnetic elements are respectively disposed in the accommodating portions. The magnetic element has an N pole and an S pole. An interface is formed at a junction between the N pole and the S pole. The extending direction of the interface passes through the axis of the rotor body.

As mentioned above, a rotor according to the present invention has a plurality of accommodating portions radially arranged around the axis such that the size of the accommodating portion depends on the size of the rotor body. Thus, the surface area of the rotor body does not restrict the area of the magnetic element. Compared with the prior art, when the number of poles of the motor rotor according to the present invention is increased, the magnetic flux of each magnetic element will not therefore be decreased. Due to the increased amount of the magnetic elements, the overall torsion of the rotor can be raised.

### BRIEF DESCRIPTION OF THE DRAWINGS

The present invention will become more fully understood from the detailed description given herein below illustration only, and thus are not limitative of the present invention, and wherein:

FIG. 1 is a perspective view showing a conventional motor rotor,

FIG. 2 is a perspective view showing another conventional motor rotor,

FIG. 3 is a front view showing a conventional motor rotor having eight poles;

FIGS. 4 and 5 are respectively a perspective view and a front view showing a motor rotor according to a first embodiment of the present invention;

FIGS. 6 and 7 are respectively a perspective view and a front view showing a motor rotor according to a second embodiment of the present invention;

FIG. 8 is a front view showing a motor rotor according to a third embodiment of the present invention;

FIG. 9 is a schematic view showing a silicon steel sheet according to a preferred embodiment of the present invention; and

FIG. 10 is a schematic view showing a silicon steel sheet according to another preferred embodiment of the present invention.

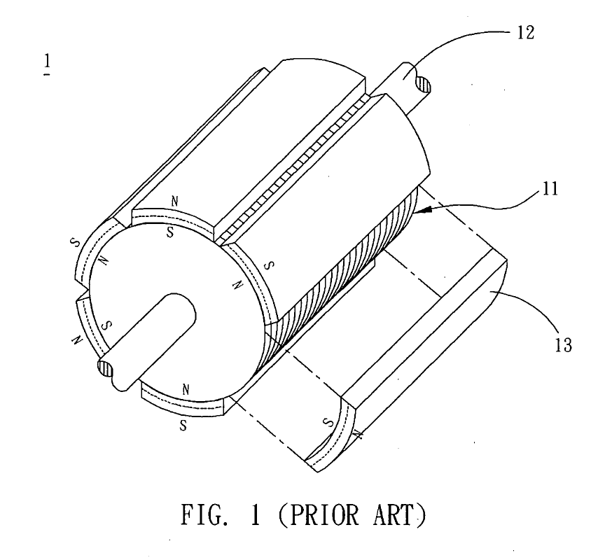

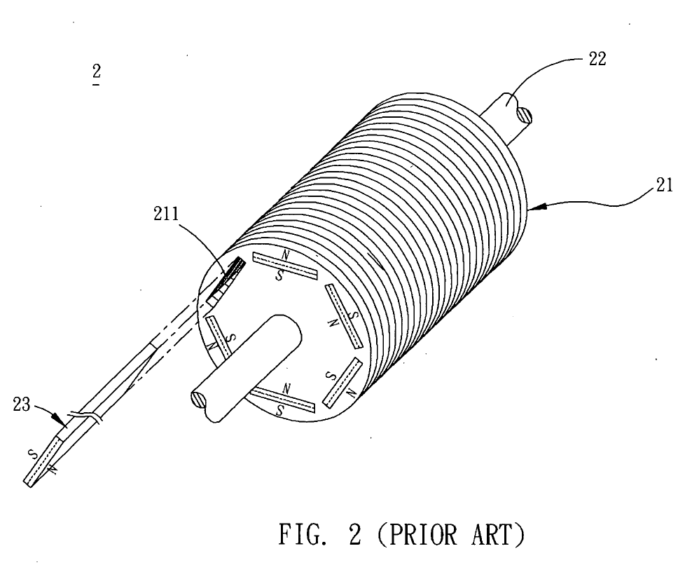

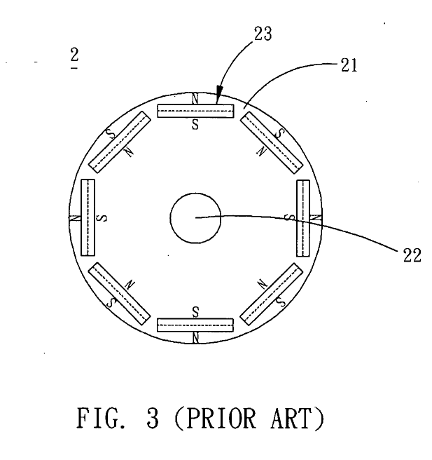

### DETAILED DESCRIPTION OF THE INVENTION

The present invention will be apparent from the following detailed description, which proceeds with reference to the accompanying drawings, wherein the same references relate to the same elements.

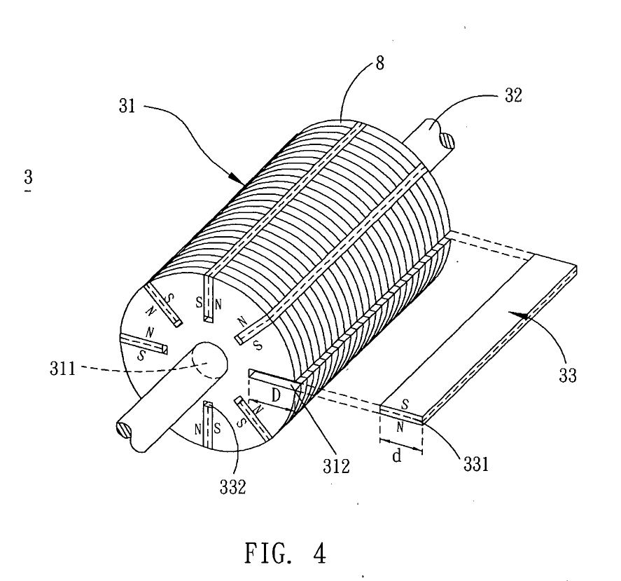

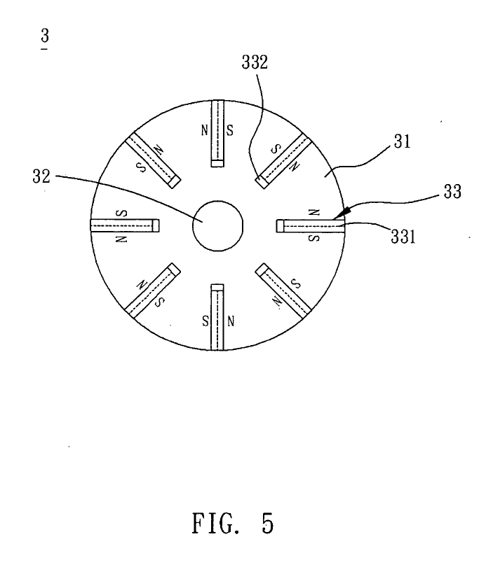

FIGS. 4 and 5 are respectively a perspective view and a front view showing a rotor according to a first embodiment of the present invention. A rotor 3, which is an inner rotor, includes a rotor body 31, a shaft 32 and a plurality of magnetic elements 33.

In this embodiment, the rotor body 31 has a through hole 311 and a plurality of accommodating portions 312. The accommodating portions 312 are radially arranged around the shaft 32 and extended toward an outer circumference of the rotor body 31. In addition, the accommodating portions 3,12 are equally spaced apart and distributed around the axis of the rotor body 31 for accommodating the magnetic elements 33.

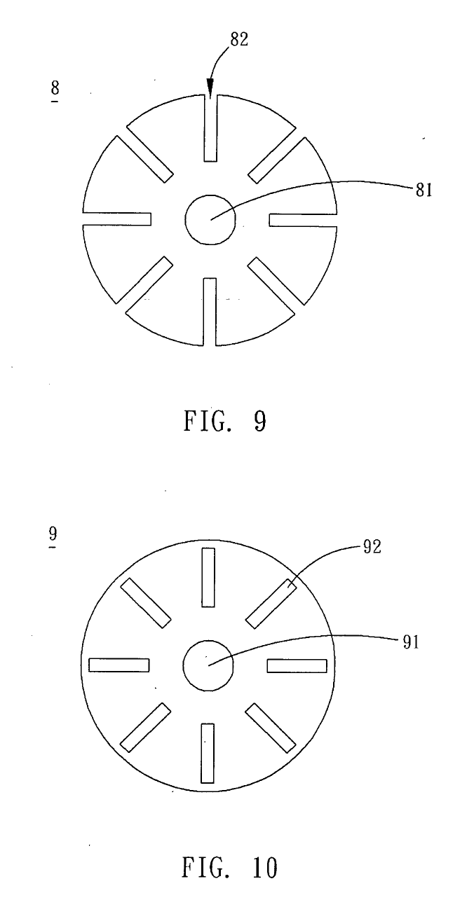

The rotor body 31 is mainly composed of a plurality of silicon steel sheets 8. Two adjacent silicon steel sheets 8 of the rotor body 31 are adhered to each other by a non-magnetic adhesive. As shown in FIG. 9, each silicon steel sheet 8 has an axial hole 81 located at a center of the silicon steel sheet 8 and a plurality of notches 82. The notches 82 are equally spaced apart and radially arranged on the silicon steel sheet 8 and around the axial hole 81. When the silicon steel sheets 8 are stacked up to form the rotor body 31, the axial holes 81 of the silicon steel sheets 8 are stacked up to form the through hole 311 and the notches 82 of the silicon steel sheets 8 are stacked up to form a plurality of slots (i.e., the accommodating portions 312). In this embodiment, the shaft 32 is disposed in the through hole 311 for driving the rotor body 31 to rotate.

In this embodiment, the magnetic element 33 is a permanent magnet having an N pole and an S pole. The junction between the N pole and the S pole of the magnetic element 33 forms an interface 331. When the magnetic element 33 is disposed in the accommodating portion 312, the extending direction of the interface 331 of the magnetic element 33 passes through the axis of the rotor body 31. It is to be noted that when the magnetic elements 33 are respectively disposed in the accommodating portions 312, the poles of any two adjacent magnetic elements 33 are sequentially arranged in an NSSN manner or an SNNS manner.

The shape of the magnetic element 33 corresponds to that of the accommodating portion 312 such that the magnetic element 33 can be fixed in the accommodating portion 312. Alternatively, the magnetic element 33 can also be fixed in the accommodating portion 312 through an adhesive. In this embodiment, a length d of the magnetic element 33 is slightly shorter than a length D of the accommodating portion 312. Thus, when the magnetic element 33 is embedded into the accommodating portion 312, a space 332 is formed at one end of the magnetic element 33 so that the phenomenon of the magnetic leakage between the end of the magnetic element 33 and the axis of the rotor body 31 is avoided.

Because the accommodating portions 312 are radially arranged around the axis of the rotor body 31, the size of the accommodating portion 312 depends on the size of the rotor body 31. In addition, because the accommodating portion 312 accommodates the magnetic element 33, the area of the magnetic element 33 is not restricted by the surface area of the rotor body 31. Thus, when the number of poles of the rotor 3 is increased, the surface area of the magnetic element 33 will not be decreased. That is, the magnetic flux of each magnetic element 33 will not be decreased. Thus, the overall torsion of the motor can be increased by increasing the number of poles of the motor. The shape of the magnetic element 33 according to the present invention only has to correspond to the shape of the accommodating portion 312 such that the magnetic element 33 can be embedded into the accommodating portion 312. The magnetic element 33 and the accommodating portion 312 can thus be easily formed. In addition, controlling the punching of the pressed shape of the silicon steel sheet 8 without precise surface treatment can reduce the space, and the manufacturing cost can be reduced accordingly.

In addition to that the rotor body 31 has the through hole 311 for accommodating the shaft 32 to pass therethrough, wo pillars can be used to insert into two ends of the rotor body 31 along an axial direction of the rotor body 31 but not pass through the rotor body 31 to serve as the shaft.

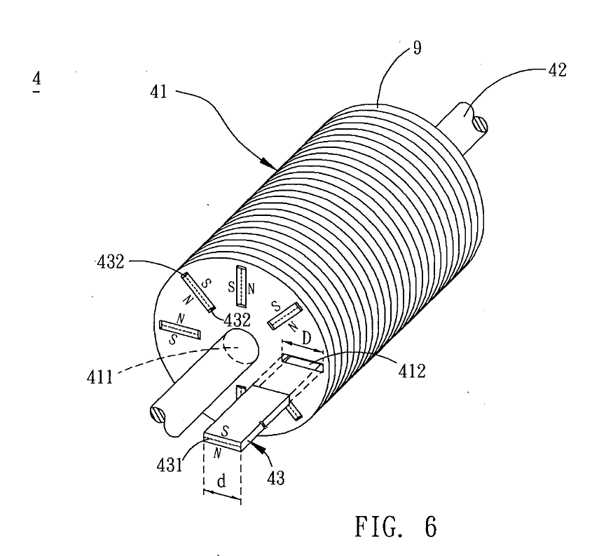

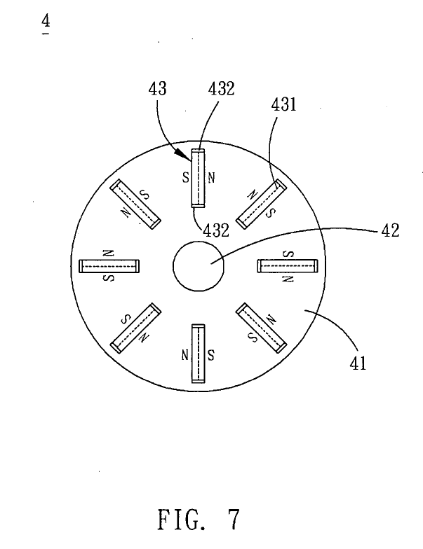

FIGS. 6 and 7 are respectively a perspective view and a front view showing a rotor according to a second embodiment of the present invention. A rotor 4, which is an inner motor rotor, includes a rotor body 41, a shaft 42 and a plurality of magnetic elements 43.

In this embodiment, the rotor body 41 has a through hole 411 and a plurality of accommodating portions 412. The through hole 411 is formed at the center of the rotor body 41. The accommodating portions 412 are radially arranged around the shaft 42 and extended toward an outer circumference of the rotor body 41. In addition, the accommodating portions 412 are equally spaced apart and distributed around the axis of the rotor body 41 for accommodating the magnetic elements 43.

The rotor body 41 is mainly composed of a plurality of silicon steel sheets 9. Two adjacent silicon steel sheets 9 of the rotor body 41 are adhered to each other by a non-magnetic adhesive. As shown in FIG. 10, each silicon steel sheet 9 has a hole 91 located at a center of the silicon steel sheet 9 and a plurality of through holes 92. The through holes 92 are equally spaced apart and radially arranged on the silicon steel sheet 9 and around the hole 91. When the silicon steel sheets 9 are stacked up to form the rotor body 41, the holes 91 of the silicon steel sheets 9 are stacked up to form the through hole 411 and the through holes 92 of the silicon steel sheets 9 are stacked up to form the accommodating portions 412. In this embodiment, the shaft 42 is disposed in the through hole 411. Of course, two pillars can be respectively inserted into two ends of the rotor body 41 along an axial direction of the rotor body 41 but not pass through the rotor body 41 to serve as the shaft.

In this embodiment, the magnetic element 43 is a permanent magnet having an N pole and an S pole. The junction between the N pole and the S pole of the magnetic element 43 forms an interface 431. When the magnetic element 43 is disposed in the accommodating portion 412, the extending direction of the interface 431 of the magnetic element 43 passes through the axis of the rotor body 41. It is to be noted that when the magnetic elements 43 are respectively disposed in the accommodating portions 412, the poles of any two adjacent magnetic elements 43 are sequentially arranged in an NSSN manner or an SNNS manner.

The shape of the magnetic element 43 corresponds to the shape of the accommodating portion 412 such that the magnetic element 43 can be fixed in the accommodating portion 412. Alternatively, the magnetic element 43 can also be fixed in the accommodating portion 412 through an adhesive. In this embodiment, a length d of the magnetic element 43 is slightly shorter than a length D of the accommodating portion 412. Thus, when the magnetic element 43 is embedded into the accommodating portion 412, two spaces 432 are formed at both ends of the magnetic element 43 so that the phenomenon of the magnetic leakage between the end of the magnetic element 43 and the axis of the rotor body 41 is avoided.

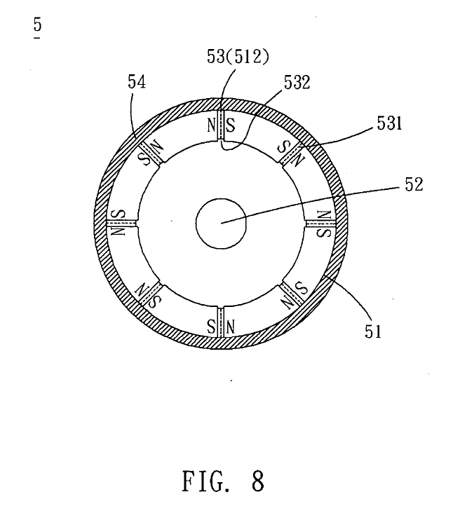

FIG. 8 is a front view showing a motor rotor according to a third embodiment of the present invention. A motor rotor 5, which is an outer rotor, includes a rotor body 51, a shaft 52 and a plurality of magnetic elements 53.

In this embodiment, the rotor body 51 has a plurality of accommodating portions 512 radially arranged around the rotor body 51. The accommodating portions 512 are extended from the shaft 52 to an outer circumference of the rotor body-51. In addition, the accommodating portions 512 are equally spaced apart and distributed around the axis of the rotor body 51 for accommodating the magnetic elements 53.

In this embodiment, the magnetic element 53 is a permanent magnet having an N pole and an S pole. The junction between the N pole and the S pole of the magnetic element 53 forms an interface 531. When the magnetic element 53 is disposed in the accommodating portion 512, the extending direction of the interface 531 of the magnetic element 53 passes through the axis of the rotor body 51. It is to be noted that when the magnetic elements 53 are respectively disposed in the accommodating portions 512, the poles of any two adjacent magnetic elements 53 are sequentially arranged in an NSSN manner or an SNNS manner.

The shape of the magnetic element 53 corresponds to the shape of the accommodating portion 512 such that the magnetic element 53 can be fixed in the accommodating portion 512. Alternatively, the magnetic element 53 can also be fixed in the accommodating portion 512 through an adhesive. In this embodiment, a length of the magnetic element 53 is slightly shorter than that of the accommodating portion 512. Thus, when the magnetic element 53 is embedded into the accommodating portion 512, a space 532 is formed at one end of the magnetic element 53. In addition, the motor rotor 5 further has a non-magnetic element 54, such as a rubber, disposed around the outer circumference of the rotor body 51 to cover the rotor body 51.

In summary, a motor rotor according to the present invention has a plurality of accommodating portions radially arranged around the axis such that the size of the accommodating portion depends on the size of the rotor body. Thus, the surface area of the rotor body does not restrict the area of the magnetic element. Compared with the prior art, when the number of poles of the motor rotor according to the present invention is increased, the overall magnetic flux of the motor rotor is thus increased. Due to the increased amount of the magnetic elements, the overall torsion of the motor rotor can be raised. In addition, the shape of the magnetic element only has to correspond to that of the accommodating portion such that the magnetic element can be embedded into the accommodating portion. Thus, the magnetic elements and the accommodating portions can thus be easily formed. In addition, controlling the punching of the pressed shape of the silicon steel sheet without precise surface treatment can effectively reduce the space, and the manufacturing cost can be reduced accordingly.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A motor rotor, comprising:
a rotor body having a plurality of accommodating portions radially arranged around an axis of the rotor body;
a shaft disposed in the axis of the rotor body; and
a plurality of magnetic elements respectively disposed in the accommodating portions, wherein the magnetic element has an N pole and an S pole, an interface is formed at a junction between the N pole and the S pole, and an extending direction of the interface passes through the axis of the rotor body.

2. The motor rotor according to claim 1, wherein the rotor body further comprises a plurality of metal sheets, each metal sheet has an axial hole located at a center of the metal sheet and a plurality of notches radially arranged around the axial hole, wherein the metal sheets are stacked up such that the notches are combined to form the accommodating portions.

3. The motor rotor according to claim 1, wherein the rotor body further comprises a plurality of metal sheets, each metal sheet has an axial hole located at a center of the metal sheet and a plurality of through holes radially arranged around the axial hole, wherein the metal sheets are stacked up such that the through holes are combined to form the accommodating portions.

4. The motor rotor according to claim 1, wherein the shapes of the accommodating portions corresponds to those of the magnetic elements such that the magnetic elements are respectively fixed in the accommodating portions.

5. The motor rotor according to claim 1, wherein the magnetic elements are respectively adhered and fixed in the accommodating portions through a non-magnetic adhesive.

6. The motor rotor according to claim 1, wherein a length of the magnetic element is slightly shorter than that of the accommodating portion such that at least one space is left between the accommodating portion and an end of the magnetic element in the extending direction of the interface.

7. The motor rotor according to claim 1, wherein the magnetic element is a permanent magnet.

8. The motor rotor according to claim 1, wherein two adjacent-magnetic elements are sequentially arranged in an NSSN manner or an SNNS manner.

9. A motor rotor, comprising:
a rotor body comprising a plurality of accommodating portions radially arranged around the axis of the rotor body; and
a plurality of magnetic elements respectively disposed in the accommodating portions, wherein a size of the magnetic element is relatively smaller than that of the accommodating portion such that there is a space formed at an end of the magnetic element after the magnetic element is disposed in the accommodating portion.

10. The motor rotor according to claim 9, wherein the rotor body further comprises a plurality of metal sheets, each of which has an axial hole located at a center of the metal sheet and a plurality of notches radially arranged around the axial hole, wherein the metal sheets are stacked up such that the notches are combined to form the accommodating portions.

11. The motor rotor according to claim 9, wherein the rotor body further comprises a plurality of metal sheets, each metal sheet has an axial hole located at a center of the metal sheet and a plurality of through holes radially arranged around the axial hole, wherein the metal sheets are stacked up such that the through holes are combined to form the accommodating portions.

12. The motor rotor according to claim 11, wherein the metal sheet is a silicon steel sheet.

13. The motor rotor according to claim 9, wherein the magnetic elements are respectively adhered and fixed in the accommodating portions through a non-magnetic adhesive.

14. The motor rotor according to claim 9, wherein the magnetic element is a permanent magnet.

15. The motor rotor according to claim 9, wherein the accommodating portions are equally spaced apart and distributed around the axis of the rotor body.

16. The motor rotor according to claim 9, wherein two adjacent magnetic elements are sequentially arranged in an NSSN manner or an SNNS manner.

17. The motor rotor according to claim 9, wherein the motor rotor is an inner rotor or an outer rotor.

18. The motor rotor according to claim 9 further comprising a shaft formed by inserting two pillars into an axial hole of the rotor body respectively from two ends of the rotor body.

19. The motor rotor according to claim 9 further comprising a non-magnetic element disposed around an outer circumference of the rotor body.

20. The motor rotor according to claim 19, wherein the non-magnetic element is a rubber.
